(19) United States
(12) Patent Application Publication
(10) Pub. No.: US 2009/0216368 A1
(43) Pub. Date: Aug. 27, 2009

(54) Method For Batching And Grading

(76) Inventor: Brynjolfur Thorsson, Reykjavik (IS)

Correspondence Address: NIXON & VANDERHYE, PC, 901 NORTH GLEBE ROAD, 11TH FLOOR, ARLINGTON, VA, 22203, US

(21) Appl. No.: 12/087,521

(22) PCT Filed: Jan. 15, 2007
(86) PCT No.: PCT/IS2007/000001

§ 371 Date: Oct. 8, 2008

(30) Foreign Application Priority Data
Jan. 19, 2006 (IS) 8245

(51) Int. Cl. G06F 7/00; B07C 5/16; B07C 5/342; B07C 5/00

(52) U.S. Cl. 700/219; 209/592; 209/580; 209/552

(57) ABSTRACT

The present invention provides a method and a system for increased efficiency during grading and/or batching. Partial batches are formed based on their characteristics and the fact that the items (1) forming a partial batch have appropriate and desired characteristics. The items (1) are then transported jointly to its destination where they form an intermediate or final batch. The present invention therefore provides a method for grading and batching items with increased efficiency. The method of the present invention is applicable to the devices and processing lines of modern item processing such as food processing lines and grading systems such as cabin grading etc.

### TECHNICAL FIELD OF THE INVENTION

The present invention relates to grading and batching items with increased efficiency. The method of the present invention is applicable to the devices and processing lines of modern item processing such as food processing lines and grading systems such as cabin grading etc.

### BACKGROUND OF THE INVENTION

It is well established that items, such as consumables, being transported on a conveyor can be weighed on the conveyor by means of a dynamic scale The displacement of the items is often handled by displacement means such as plastic or metal arms used for displacing or moving selected items, based on features such as the type of item or its weight, from the conveyor into a receiving bin. Consumables of various types are further packed and sold in batches from the producer. As an example, items of non-uniform size shape or weight, e.g. food items such as meat, fish, fruit and vegetables, are typically handled and delivered to customers in batches having a substantially uniform size, shape and weight. In general, a batch of items must fulfill requirements defined by a contract between a delivering and a receiving part, and most often, minimum weight of the batch is a key issue.

Standard applications include one or several conveyors for transporting items along a production line. The items can be moved on a conveyor belt, or they can be placed into a container which is located on the conveyor, and is used to transport the items to their destination point, where the container is emptied or its contents otherwise processed. One example of such a use is the transport of luggage at e.g. airports.

Combination weighing apparatuses are widely used, where batches of items with a predetermined weight obtained by individual weighing of each item before the items are combined in batches. Such combination weighing apparatuses are often supplied with an in-feed mechanism, for automated in-feeding of articles to the batching station.

EP 1,225,430 discloses a combination weighing apparatus in which items placed in a plurality of hoppers and a combination weighing takes places such that the total weight of the articles is within a predetermined weight range. The items held in normal weighing hoppers are selected and a combination weighing takes place. Special items can also be held in a special weighing hopper specified according to a specification routine and discharged appropriately.

U.S. Pat. No. 6,268,571 discloses a counting and combinatorial weighing method for obtaining a collected batch of ingredients of a plurality of types, having a predetermined fractional weight. The method provides a plurality of weighing machines, each of them is for one corresponding group of different ingredients including at least one main ingredient and a plurality of incorporated ingredients. The method comprises the steps of modeling a weighing system, simultaneous weighing according to target weight values the n equal partial batches of the main ingredient within all the n associated weighing scale modules of each weighing machine. The partial batches are discharged into a discharging device, and the total weight is counted. These weighing and counting steps are repeated in succession up to k times, thus the total weight being less than the predetermined fractional weight is obtained. Further batches of at least the n different incorporated ingredients within each of the weighing machines are weighed and discharged to the discharging device and all these total weights obtained are counted.

### SUMMARY OF THE INVENTION

The present invention provides a method and a system for increased efficiency during grading and/or batching, which has the advantage that one or more items are characterized simultaneously during transport. The item(s) are transported to a transport device, which has a separated area for each batch, where they form partial batches. The partial batches are formed based on their characteristics and the fact that the items forming a partial batch have appropriate and desired characteristics. As each partial batch is formed its destination is also determined. In this way, several items may be characterized simultaneously, immediately making up a single batch. These items are then transported together to its destination where they form an intermediate batch. So instead of characterizing one item and transporting that item to its destination, a plurality of items are characterized and transported together to its destination, which increases the efficiency of the batching process. Although several items are characterized simultaneously, the method may select only one of the items to become a partial batch or even only a few of may items characterized, allowing a more flexible system and providing options to create intermediate or full batches with minimal deviation form a desired batch.

### DESCRIPTION OF THE INVENTION

In a first aspect of the present invention a method for batching items is disclosed. The method comprising the steps of:
receiving items,
characterizing the items,
determining the at least one characteristic
forming partial batches, and
selecting destination for the partial batches.

The method is characterized in that one or more items are characterized simultaneously forming one or more of the partial batches. The partial batches are further discharged at the selected destination based on the partial batch characteristic.

In an embodiment of the present invention a method for batching items is disclosed, where the method comprises the steps of:
receiving items from an in-feed means,
characterizing one or more items simultaneously by means for characterizing items,
determining the at least one characteristic and destination of the items, forming partial batches,
transporting the partial batches on a transporting means from the means for characterizing items to receiving means, and
discharging the partial batches of the transporting means to form intermediate batches of known characteristics.

The method is characterized in that the partial batches comprise one or more of the items and the one or more intermediate batches are selected to form complete/full batches. The items are transported to an area of characterization by means of an in-feed device. The in-feed device can be an in-feed conveyor, a robot or any receptacle which delivers the items to the area of characterization.

In the present context the area of characterization or characterization station can be an area on a conveyor belt, such as a dynamic scale, or where a camera is placed above the belt, or where a human is placed next to the belt assigning the items to a category. The area of characterization can also be a separate station in a processing line, such as a scale, or an area where an imaging means is positioned at to perform imaging analysis of the items. The imaging means can be a camera or an x-ray device or any other imaging means. The area of characterization can comprise one or more characterization stations which receive items from one or more in-feed devices. The characterization stations can further be robot(s) with an implemented characterization device, such as a weight-cell built into the claw. The items are therefore weighted as they are being transported to the transport means, which transports items jointly to their destination.

As one or more items are assigned to a partial batch, they are transported to the next transport device, which has a defined/separated area for each partial batch. The defined/separated areas can be equipped with releasing or discharging mechanism for delivering each partial batch to a collection device.

The items to be graded and batched are food items such as fish or meat pieces or parts of animals such as chicken parts. The items can also be fruits or vegetables.

The at least one characteristic of the item characterized in the method of the present invention is selected from, but not limited to weight, shape, quality or color as well as type of items such as chicken parts or fish parts.

The characteristic of the items is according to the present invention obtained by means such as a camera, weighing means such as scales, where the scales can be dynamic scales, a human or by a color grading mechanism.

In an embodiment of the present invention intermediate batches are formed after the items are characterized and one or more of said intermediate batches form a partial batch. Formation of intermediate batches is used where more than one in-feed line is used. One or more items are characterized by one or more characterization means on/over or after each in-feed line or at a single characterization station at a meeting point for all the in-feed lines. One or more items are then transported as intermediate batches from the characterization station(s) on an intermediate transport means to form partial batches on a separate transport means, which will transport the partial batches to their destination.

In an embodiment of the present invention the means for transporting partial batches has separated areas for each partial batch to be transported in, such as a conveyor belt where the belt has separated areas. When a batch of items is transferred over to the belt, each batch is transferred to a separate area. Such a means for transporting partial batches is according to one embodiment of the present invention a cabin grader.

In a second aspect of the present invention a computer program product, directly loadable into the internal memory of a digital computer is provided. The computer program product comprises software code portions for interacting with the computer operator to perform the method described above, when the product is run on a computer.

Furthermore, a computer program product for operating a computer is disclosed, where the computer program product comprises a computer readable medium and program instruction means, recorded on said medium, for instructing a computer processor to perform the following:
to process information for locating item being transported on an in-feed means;
to operate at least one characterizing means to register at least one characteristic property of one or more items simultaneously;
to determine at least one characteristic property and destination of said items of said items, as well as forming partial batches containing one or more of said characterized items;
to transfer said partial batches on a transporting means from said means for characterizing items to receiving means;
to control discharge of said partial batches of the transporting means into receptacles batches of known characteristics; and
to control interaction between interaction between an operator and said computer program product via human machine interface;
   where the computer program controls the batching via hardware/software interface devices.

A computer program product directly loadable into the internal memory of a digital computer, comprising software code portions for interacting with the computer operator via human machine interface to perform the method according to the method of the invention when the product is run on a computer.

In the present context, the human machine interface is a graphical user interface (GUI) or a command line interface.

In an embodiment of the present invention items are transferred to the area of characterization stations by means of a robot. The items are then transferred from the area of characterization onto a transfer means by a robot or any other means for picking up or pushing the items over to a transfer means.

### DETAILED DESCRIPTION OF THE INVENTION

The present invention is described in detail below with reference to the following drawing figures of which:

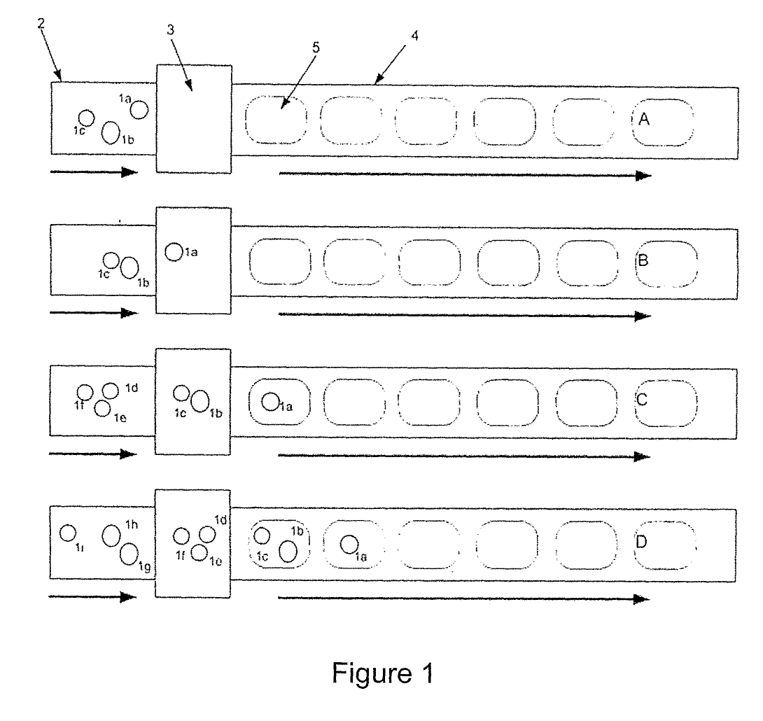

FIG. 1 FIG. 1 A-D shows items being graded and forming of batches from the graded items.

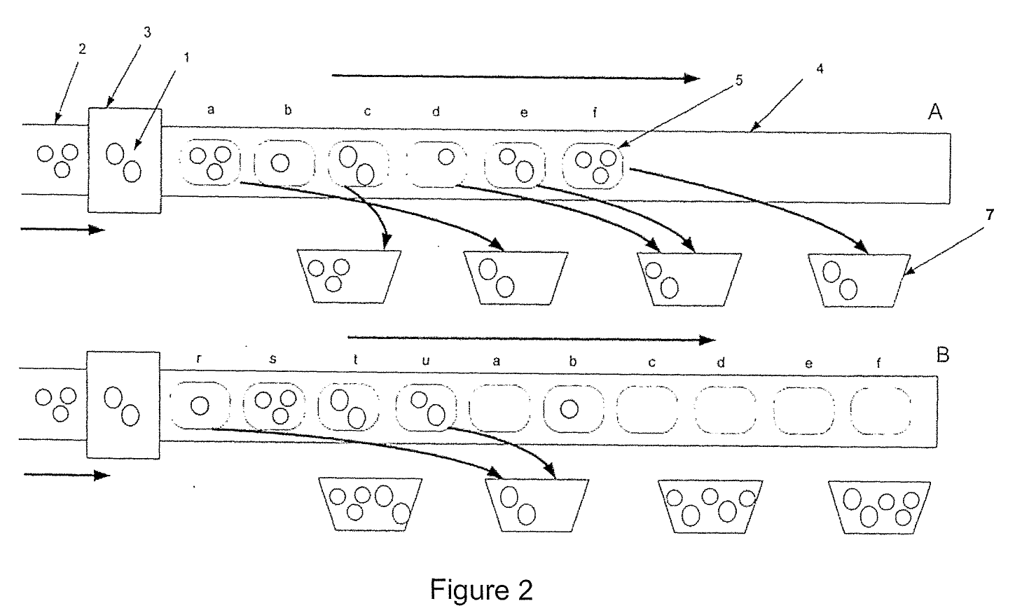

FIG. 2 FIG. 2 A and B shows items being graded and forming of batches from the graded items.

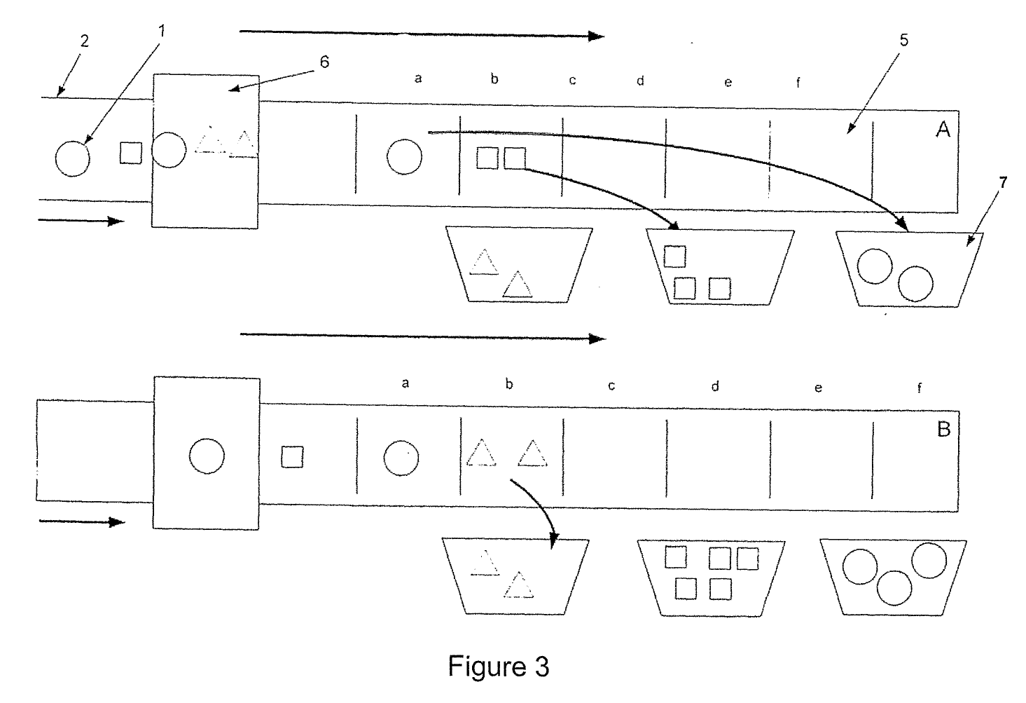

FIG. 3 FIG. 3 A and B shows items being graded and forming of batches from the graded items.

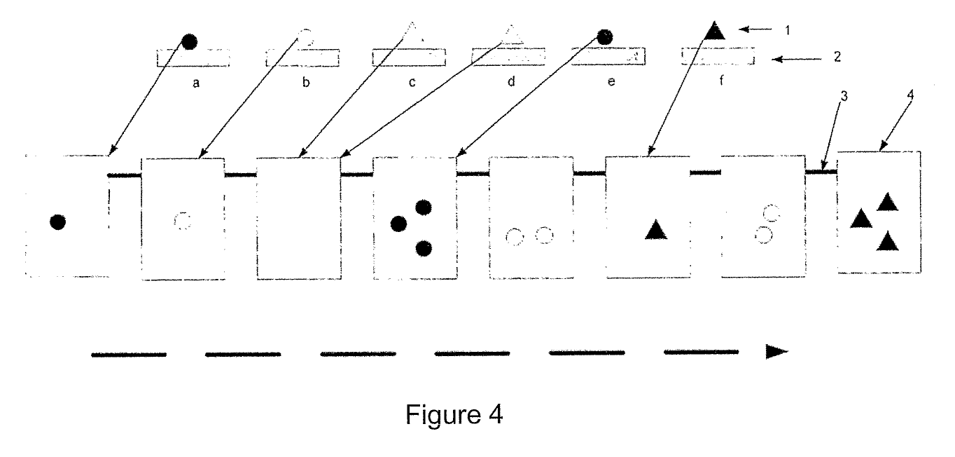

FIG. 4 FIG. 4 shows formation of partial batches based on the shape and color determined at a plurality of characterization stations.

This example shows where the weight of the items is determined by a scale and the arrows show the transport direction of the items. The items then form partial batches and their termination into a final batch is determined as the items are transported from the scale and to receptacles. Items (1) are transported on an in-feed conveyor (2) to the scale (3) and the weight of one or more items is determined as the items are transported over the scale (3). In this example items 1a, 1b and 1c arrive on the in-feed conveyor (2) in FIG. 1A. The weight of item 1a is determined separately and forms a partial batch as shown in FIGS. 1B and 1C. The weight of items 1b and 1c is determined simultaneously and together items 1b and 1c form one partial batch (see FIG. 1D). FIGS. 1C and 1D show how the items are transported from the scale (3) by a partial batch conveyor belt (4), where the partial batch conveyor belt (4) has defined areas (5) for transferring each partial batch to a desired location. FIGS. 1C and 1D also show how new items 1d-1i arrive on the in-feed conveyor and in FIG. 1D, items 1d-1f are weighted.

FIG. 2 A and B shows items being graded and forming of batches from the graded items. This example shows where the items are characterized by weight and the arrows show the transport direction of the items. The items then form partial batches and their termination into a final batch is determined as the items are transported from the scale and to receptacles. Items (1) are transported on an in-feed conveyor (2) to the scale (3) and the weight of one or more items is determined as the items are transported over the scale (3). In this example items arrive on the in-feed conveyor and the weight of the items arriving together is determined simultaneously (FIG. 2A). The group of items having their weight determined simultaneously form batches in defined areas 5a-5f on the partial batch conveyor belt (4). After the weight of all the items in each partial batch has been registered, the destination of each partial batch is determined and it forms an intermediate batch in receptacles (7). FIG. 2B shows how new partial batches arrive on defined areas 5r-5u on the partial batch conveyor belt (4). The weight of the new partial batches is determined and the destination in intermediate batches is also determined.

FIG. 3 A and B shows items being graded and forming of batches from the graded items. The shape of the items is determined by a camera and the arrows show the transport direction of the items. The items then form partial batches based on their shape and their termination into a final batch is determined as the items are transported from the scale and to receptacles. Items (1) are transported on an in-feed conveyor (2) to the area of detection (6) and the shape of one or more items is determined as the items are transported over the area of detection (6). In this example items arrive on the in-feed conveyor and the shape of the items arriving together is determined simultaneously (FIG. 3A). The group of items having their shape determined simultaneously may form partial batches in defined areas 5a-5f on the partial batch conveyor belt (4). After the shape of all the items in each partial batch has been registered, the destination of each partial batch is determined and it forms an intermediate batch in receptacles (7). FIG. 3B shows the route of the items characterized in FIG. 2a as partial batches and their destination. In this example items with same characteristics are batched together, so when a plurality of items with different characteristics are characterized together, the items are divided into two or more partial batches.

FIG. 4 shows an embodiment, where the shape and color of the items is determined at a plurality of characterization stations. The items can enter the area(s) of characterization from one or many in-feed channels, such as in-feed conveyors. As each item is characterized, the destination on the transport mean is determined according to the characteristics of the item. In the example illustrated in FIG. 4 items of similar shape and color are transported jointly. Items (1) arrive at the area of characterization (2). In this example there are six individual characterization stations (2 a-f), which determine both shape and color of the items. A conveyor (3), comprising compartments (4) runs below the characterization stations (2 a-f). Such a grader can be a carousel or a cabin grader. The broken arrow shows the direction of transportation.

The present invention provides a method for systems and devices, where items are characterized and then transported for batching and/or grading. A preferred embodiment uses a transportation system with defined areas for transporting one or more items jointly to their mutual destination. The items are selected for the same destination based on their characteristics, such as but not limited to weight, shape, size, color and/or because they fulfill a criteria for a desired and predetermined weight or combination. The system determines which items can be transported jointly to the same destination according to predetermined rules each time. The system can characterize one or more items simultaneously, either on one or a plurality of characterization stations. A system working according to the method of the present invention, which has a transport system with compartments and where each compartment fits up to 5 items and wherein the speed of the transport system is 100 compartments/minute can then transport between 100-500 items per minute.

1. A method for batching items, said method comprising the steps:
receiving items,
characterizing said items,
determining the at least one characteristic of said items
forming partial batches of one or more items,
select destination for said partial batches,
characterized in that the destination for said partial batch is determined after each partial batch is formed and all items of said partial batch are transported jointly to the selected destination.

2. A method according to claim 1, wherein the at least one characteristic of the item is weight, shape, quality or color.

3. A method according to claim 1, wherein the characteristic of said items is obtained by imaging.

4. A method according to claim 1, wherein the characteristic of said items is obtained by a weighing.

5. A method according to claim 1, wherein the characteristic of said items is obtained by a human.

6. A method according to claim 1, wherein the characteristic of said items is obtained by a color grading.

7. A method according to claim 1, wherein intermediate batches are formed after the items are characterized and one or more of said intermediate batches form a partial batch.

8. A method according to claim 1, wherein the batches are transported in separated areas for each partial batch.

9. A computer program product directly loadable into the internal memory of a digital computer, comprising software code portions for:
interacting with the computer operator to perform the method according to claim 1, and
when said product is run on a computer.

10. A computer program product for operating a computer, said computer program product comprising:
computer readable medium;
first program instruction means, recorded on said medium, for instructing a computer processor to process information for locating item being transported on an in-feed means;
second program instruction means, recorded on said medium, for instructing a computer processor to operate at least one characterizing means to register at least one characteristic property of one or more items;
third program instruction means, recorded on said medium, for instructing a computer processor to determine at least one characteristic property and destination of said items of said items, as well as forming partial batches containing one or more of said characterized items;
fourth program instruction means, recorded on said medium, for instructing a computer processor to transfer said partial batches on a transporting means from said means for characterizing items to receiving means;
fifth program instruction means, recorded on said medium, for instructing a computer processor to control discharge of said partial batches of the transporting means into receptacles batches of known characteristics;
sixth program instruction means, recorded on said medium, for instructing a computer processor to control interaction between interaction between an operator and said computer program product via human machine interface;
wherein said computer program controls the robot via hardware/software interface circuits.

11. A computer program product according to claim 9, wherein said human machine interface is a graphical user interface (GUI).

12. A computer program product according to claim 9, wherein said human machine interface is a command line interface.
